(19) United States
(12) Patent Application Publication
(10) Pub. No.: US 2008/0183568 A1
(43) Pub. Date: Jul. 31, 2008

(54) ADVERTISEMENT INFORMATION MANAGEMENT APPARATUS AND ADVERTISEMENT INFORMATION MANAGEMENT METHOD

(75) Inventors: Toshihiro Ida, Tokyo (JP); Kazuhiro Ogura, Kanagawa-ken (JP); Shinji Makishima, Tokyo (JP); Akihiro Mizutani, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/668,162

(22) Filed: Jan. 29, 2007

(51) Int. Cl. G06Q 30/00

(52) U.S. Cl. 705/14

(57) ABSTRACT

When image data is transmitted from an image forming apparatus through a network, advertisement information is added to the image data and transmitted only when a cellular phone on a reception side desires to receive the advertisement information.

An advertisement information management apparatus of the invention includes an advertisement-information displaying unit (i.e., a display unit 12 in a touch panel display 11 in FIG. 7) that acquires and displays one or plural kinds of advertisement information, a reading and writing unit (i.e., the cellular phone 6 and a card reader 7 in FIG. 7) that reads information recorded in an IC card built in a cellular phone 6 and writes new information in the IC card, and a transmitting unit (i.e., communicating means between the cellular phone 6 and the card reader 7 in FIG. 7) that transmits the advertisement information displayed by the advertisement-information displaying unit to the IC card by reading the information recorded in the IC card with the reading and writing unit.

### BACKGROUND OF THE INVENTION

1. Field of the Invention

The present invention relates to an advertisement information management apparatus and the like for performing management of advertisement information transmitted through a network, and, more particularly to an advertisement information management apparatus and an advertisement information management method for performing management of advertisement information added to image information and transmitted from an image forming apparatus connected to a network.

2. Description of the Related Art

In recent years, a technique for adding, when image data is transmitted from an image forming apparatus such as a printing apparatus or an MFP (Multi Function Printer) through a network, advertisement information and the like to the image data and transmitting the advertisement information is spread. For example, a technique with which, when a user attempts to transmit image data or music data from a printing apparatus installed in a shop or the like to a cellular phone or the like, advertisement information of the shop, a shopping district near the shop, commercial facilities, and the like are added to the image data or the music data and transmitted to the cellular phone together with the image data or the music data is reported in, for example, a patent document 1 (JP-A-2005-71271). Since the advertisement information is added to the image data or the like and transmitted in this way, sponsors and agents can count on advertisement charge earnings.

However, in the conventional techniques, when the user attempts to execute printing using the printing apparatus installed in the shop or the like and transmit data, regardless of whether the user desires, the advertisement information is added to the image data or the music data and transmitted by electronic mail. Therefore, inevitably, a data volume transmitted from the printing apparatus increases and the cellular phone on a reception side receives undesired large data. As a result, on the cellular phone side, it takes long to perform processing for opening the large data. For the cellular phone side, since the large data has to be received, it is also likely that a communication state is congested. Moreover, since the cellular phone side has to receive information with a large data volume, communication cost inevitably increases.

### SUMMARY OF THE INVENTION

The invention has been devised to solve the problems and it is an object of the invention to provide an advertisement information management apparatus and an advertisement information management method with which a user can acquire only desired advertisement information.

In order to solve the problems, an advertisement information management apparatus according to the invention includes an advertisement-information displaying unit that acquires and displays one or plural kinds of advertisement information and a reading and writing unit that reads information recorded in an IC card and writes new information in the IC card. The reading and writing unit transmits the advertisement information displayed by the advertisement-information displaying unit to the IC card by reading the information recorded in the IC card.

An advertisement information management apparatus according to the invention includes advertisement-information displaying means for acquiring and displaying one or plural kinds of advertisement information and reading and writing means for reading information recorded in an IC card and writing new information in the IC card. The reading and writing means transmits the advertisement information displayed by the advertisement-information displaying means to the IC card by reading the information recorded in the IC card.

The invention provides an advertisement information management method of causing a computer to execute management of advertisement information, the advertisement information management method including an advertisement-information displaying step of acquiring and displaying one or plural kinds of advertisement information, an information reading step of reading information recorded in an IC card, and a transmitting step of transmitting the advertisement information displayed in the advertisement-information displaying step to the IC card by reading the information recorded in the IC card in the information reading step.

### DESCRIPTION OF THE DRAWINGS

FIG. 1 is a conceptual diagram of an advertisement information management system applied to a first embodiment of the invention;

FIG. 2 is a diagram showing an example of a screen on which a touch panel display of an image forming apparatus 5 shown in FIG. 1 displays shop information as advertisement information;

FIG. 3(a) is a diagram showing an example of a display screen of shop information received by a cellular phone 6 and is a list screen of advertisement information acquired;

FIG. 3(b) is a screen at the time when a shop name B is selected on the screen in FIG. 3(a);

FIG. 3(c) is a screen at the time when a book title A is selected on the screen in FIG. 3(a);

FIG. 4(a) is an example of an advertisement-information retrieval screen displayed by the cellular phone 6 and is a screen for selecting a genre of advertisement information;

FIG. 4(b) is a detailed screen at the time when a genre of books is selected on the screen in FIG. 4(a);

FIG. 5 is a flowchart showing a flow of operations of an advertisement-information management server 4 shown in FIG. 1;

FIG. 6(a) is a flowchart showing a flow of an advertisement-information display operation of the image forming apparatus 5;

FIG. 6(b) is a flowchart showing a flow of an advertisement-information transmission operation of the image forming apparatus 5;

FIG. 7 is a partial detailed diagram of an advertisement information management system 1 applied to a second embodiment of the invention and is a block diagram showing an internal structure at the time when the image forming apparatus 5 shown in FIG. 1 is an MFP;

FIG. 8 is a diagram showing an example of a screen of a recommended book list acquired by an image selecting unit 14 of the image forming apparatus 5 shown in FIG. 7 using an OCR function in the second embodiment of the invention;

FIG. 9 is a flowchart showing a flow of processing in which the image selecting unit 14 of the image forming apparatus 5 shown in FIG. 7 creates a book list using the OCR function in the second embodiment of the invention;

FIG. 10 is a conceptual diagram of an advertisement information management system applied to a third embodiment of the invention; and

FIG. 11 is a flowchart showing a flow of advertisement information after user authentication in an advertisement information management system 1a shown in FIG. 10.

### DESCRIPTION OF THE EMBODIMENTS

Advertisement information management systems according to embodiments of the invention will be hereinafter explained in detail with reference to the drawings.

### First Embodiment

FIG. 1 is a conceptual diagram showing an advertisement information management system according to a first embodiment of the invention.

An advertisement information management system 1 according to this embodiment includes plural terminal apparatuses 3-1, 3-2, 3-3, 3-4, . . . 3-n and an advertisement information management server 4 connected to a network 2, an image forming apparatus 5, a cellular phone mounted with non-contact IC card 6, and a card reader 7 attached to the image forming apparatus 5.

In the first embodiment, the advertisement information management apparatus of the invention is constituted by the image forming apparatus 5.

The terminal apparatus 3-1, the terminal apparatus 3-2, the terminal apparatus 3-3, and the terminal apparatus 3-4 have functions of transmitting “shop information”, “book information”, “new music information”, and “event information” to the advertisement information management server 4 via the network 2, respectively.

The advertisement information management server 4 has a function of arranging information (e.g., shop information, book information, new music information, and event information) received from the respective terminal apparatuses 3-1 to 3-n and transmitting the information to the image forming apparatus 5 as advertisement information.

The image forming apparatus 5 has a function of receiving the advertisement information arranged by the advertisement information management server 4, displaying those kinds of advertisement information on a touch panel display (see FIG. 4) or a control panel, and transmitting and outputting those kinds of advertisement information to the outside with the card reader 7 attached to the image forming apparatus 5 using a radio wave.

The touch panel display or the control panel constitutes the advertisement-information displaying unit or the advertisement-information displaying means of the invention.

The cellular phone mounted with non-contact IC card (hereinafter simply referred to as cellular phone as well) 6 has a function of receiving the advertisement information displayed on the touch panel display from the image forming apparatus 5 via the card reader 7 and recording the advertisement information.

The card reader 7 constitutes the reading and writing unit or the reading and writing means of the invention.

A structural form of “shop information”, “book information”, “new music information”, and “event information” includes a simple introductory sentence to be displayed on the touch panel display of the image forming apparatus 5, an image, a moving image, and a URL to a mobile Web page as information to be transmitted to the cellular phone 6 via the card reader 7.

Operations of the advertisement information management system shown in FIG. 1 will be explained.

When “shop information” of restaurants, bookstores, and the like in the neighborhood, “book information” and “new music information” of books and music that are planned to be sold soon and ranked high in a sales ranking, “event information” of concerts planned to be held soon, and the like are transmitted from the terminal apparatuses 3-1 to 3-n to the advertisement information management server 4 via the network 2, respectively, those kinds of information are arranged by the advertisement information management server 4 and then transmitted to the image forming apparatus 5 as advertisement information.

The image forming apparatus 5 displays the “shop information”, the “book information”, the “new music information”, the “event information”, and the like as individual pieces of advertisement information using the touch panel display or the like mounted on the image forming apparatus 5.

When the cellular phone 6 mounted with the non-contact IC card is held over the card reader 7, the cellular phone 6 can acquire the advertisement information (e.g., the new music information) displayed on the touch panel or the control panel of the image forming apparatus 5 at that timing.

It is possible to include not only information, contents of which can be checked later, but also a coupon in advertisement information that the cellular phone 6 can acquire. It is also possible to perform a procedure for purchasing a ticket or the like using the advertisement information acquired.

As a precondition, the cellular phone 6 is mounted with management software for managing advertisement information in advance. A function identical with that of the advertisement information management server 4 may be provided in the image forming apparatus 5.

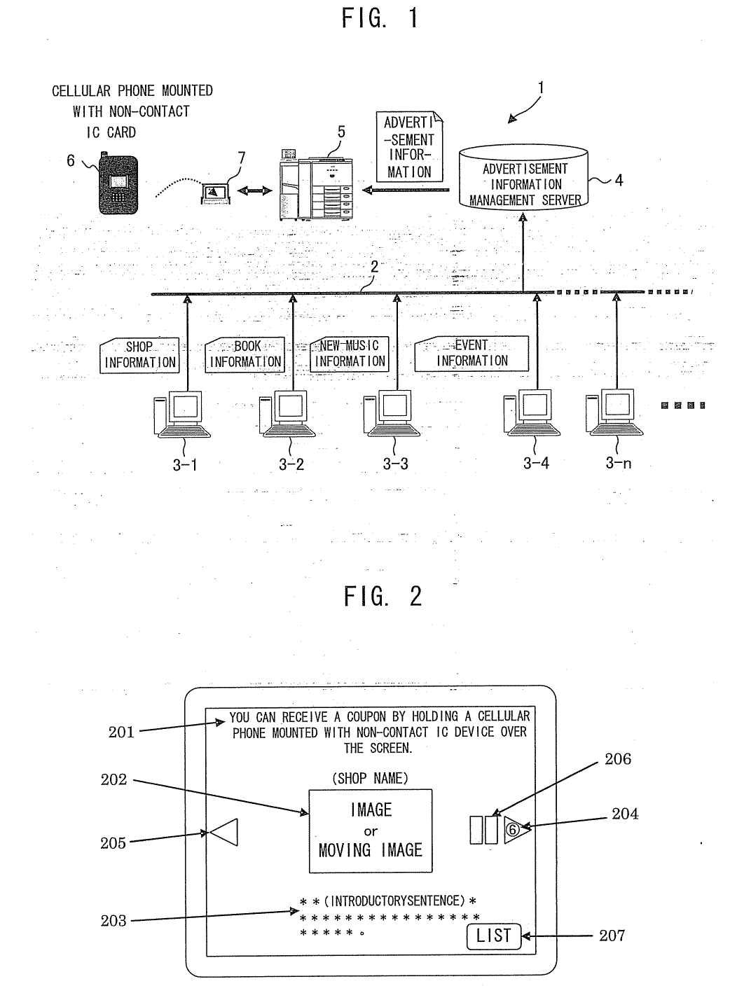

FIG. 2 is a diagram showing an example of a screen on which the touch panel display of the image forming apparatus 5 shown in FIG. 1 displays shop information as advertisement information.

It is possible to inform a user of a method of use by displaying, as indicated by reference numeral 201, a telop “You can receive a coupon by holding a cellular phone mounted with non-contact IC device over the screen” on this touch panel display screen. It is possible to display the appearance and the interior of a shop on an image or a moving image 202. Moreover, as an introductory sentence 203, it is possible to display recommended commodities, addresses of shops that sell the commodities, and the like.

It is possible to switch the advertisement information displayed here to the next advertisement information (e.g., book information) when the user touches a button 204 of the touch panel display. A number displayed in the button 204 of the touch panel display represents time (seconds) in which display contents of the advertisement information are automatically switched. When this number changes to 0, the advertisement information is switched to the next advertisement information. Moreover, when the user touches a button 205 of the touch panel display, immediately preceding advertisement information is displayed. When the user touches a button 206 of the touch panel display, the user can stop countdown of the number of the button 204 of the touch panel display. In other words, the user can stop the switching of the advertisement information displayed to the next advertisement information. When the user pushes the button 206 of the touch panel display again, the countdown of the number of the button 204 of the touch panel display is resumed. Moreover, when the user touches a list button 207 of the touch panel display, the user can display, for each genre, a screen on which the user directly selects desired advertisement information.

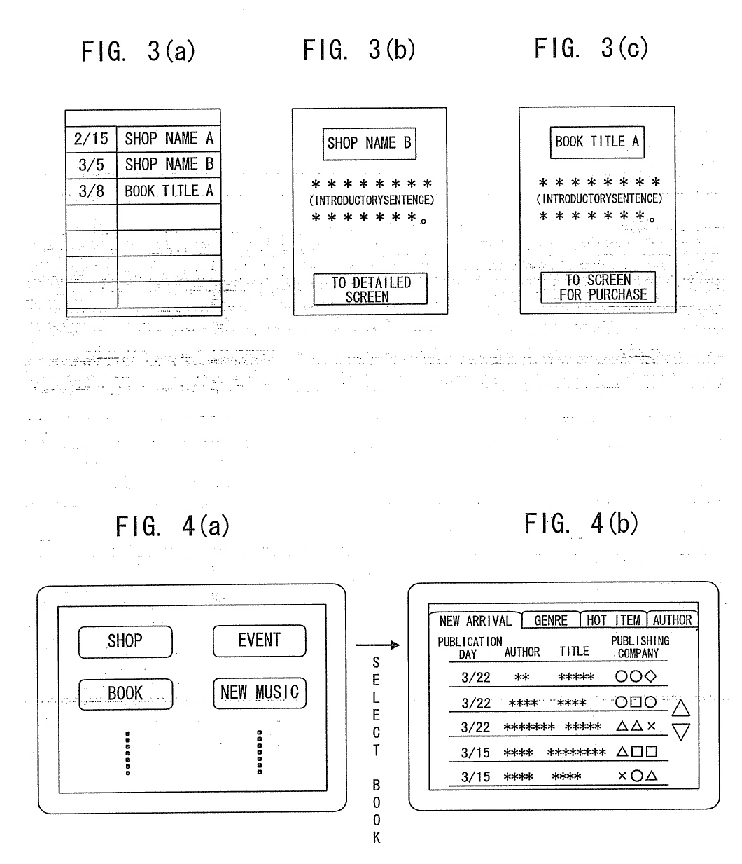

FIG. 3 is a diagram showing examples of the display screen for the shop information received by the cellular phone 6. FIG. 3(a) shows a list screen of the advertisement information acquired, FIG. 3(b) shows a screen at the time when a shop name B is selected on the list screen in FIG. 3(a), and FIG. 3(c) shows a screen at the time when a book title A is selected on the list screen in FIG. 3(a). When the user selects “to a detailed screen” on the selection screen of the shop B shown in FIG. 3(b), the cellular phone 6 acquires a screen on which detailed information such as an address of the shop, prices of commodities, and the like are described and displays the screen using a network function provided in the cellular phone 6 in advance. When the user selects “to a purchase screen” in FIG. 3(c), the user can proceed to a screen on which the user can perform a purchase procedure for the book.

FIG. 4 is a diagram showing examples of an advertisement information retrieval screen displayed by a displaying unit such as the touch panel display of the image forming apparatus 5. FIG. 4(a) shows a screen on which a genre of advertisement information is selected and FIG. 4(b) shows a detailed screen at the time when a genre of a book is selected on the advertisement information retrieval screen. On the screen in FIG. 4(a), icons that allow the user to select advertisement information for each field are displayed. For example, when the user selects an icon on which “book” is displayed, a detailed screen of a book genre shown in FIG. 4(b) is displayed. On the screen in FIG. 4(b), there are tabs “new arrival”, “genre”, “hot item”, and “book” and it is possible to switch a retrieval mode as appropriate.

In this case, data such as an image and a moving image of the respective pieces of advertisement information are not transmitted to the image forming apparatus 5. Data transmitted to the image forming apparatus 5 are only data such as a publication day, an author, and a title. The screens in FIGS. 4(a) and 4(b) return to the advertisement information screen in FIG. 2 when a fixed time (e.g., 60 seconds) elapses.

The touch panel displays constitutes a retrieving unit or retrieving means of the invention. The operation shown in FIG. 4 constitutes a retrieving step of the invention.

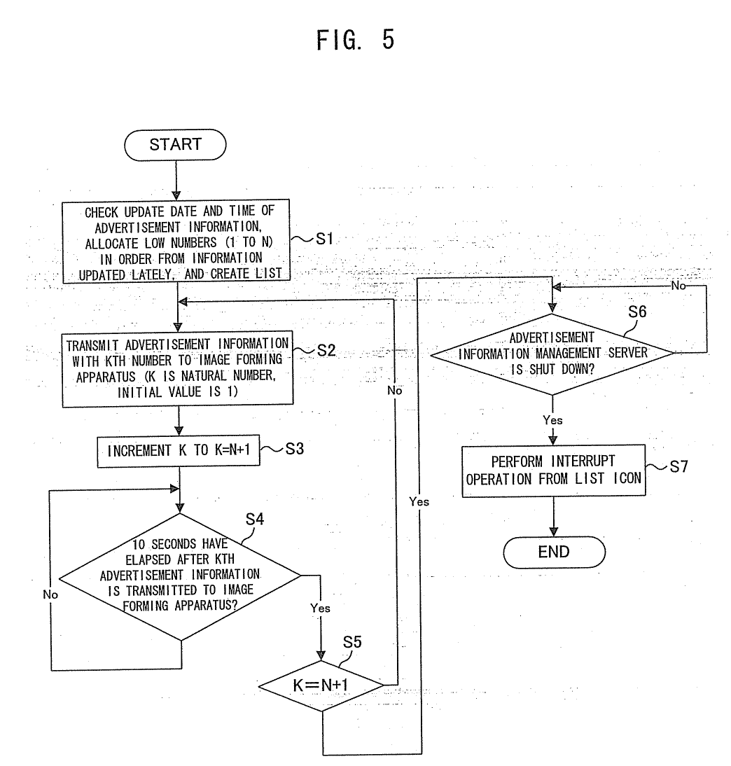

FIG. 5 is a flowchart showing a flow of operations of the advertisement information management server 4 shown in FIG. 1. This flowchart shows operations of the advertisement information management server 4 at the time when the advertisement information management server 4 transmits new advertisement information to the image forming apparatus 5.

First, the advertisement information management server 4 checks a date when advertisement information recorded in a database of the advertisement information management server 4 is recorded, allocates low numbers N in order from a latest piece of advertisement information, and creates a list of numbers 1 to N (step S1). The low numbers N are natural numbers starting from 1.

The advertisement information management server 4 transmits advertisement information with a Kth number to the image forming apparatus 5 (step S2). An initial value of K is 1. The advertisement information management server 4 increments K by 1 to K=K+1 (step S3).

The advertisement information management server 4 determines whether a predetermined time (e.g., 10 seconds) has elapsed after the Kth advertisement information is transmitted to the image forming apparatus 5 in step S2 (step S4). When the predetermined time has elapsed (step S4, Yes), the advertisement information management server 4 repeats the processing in steps S2 to S4 until K reaches N+1 (step S5, No).

On the other hand, when K reaches N+1, assuming that the advertisement information of all the numbers are transmitted to the image forming apparatus 5 (step S5, Yes), the advertisement information management server 4 finishes the operations for transmitting the advertisement information by the advertisement information management server 4. On the other hand, the advertisement information management server 4 determines presence or absence of a shutdown as an interrupt from the image forming apparatus 5 side (step S6).

When there is a shutdown (step S5, Yes), the advertisement information management server 4 determines that a “list” icon of the touch panel display shown in FIG. 2 is selected and interrupt operation is performed and performs processing in accordance with the operation (step S7).

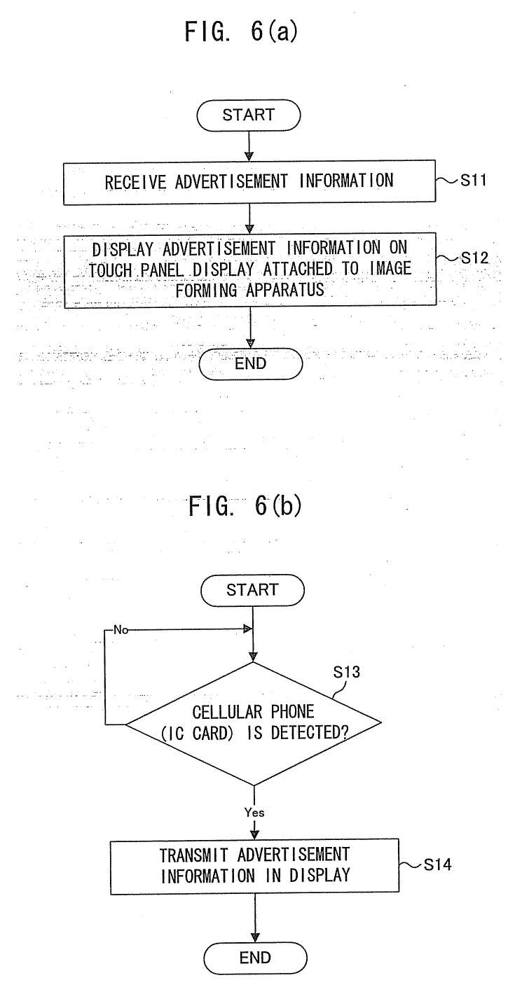

FIG. 6(a) is a flowchart showing a flow of an advertisement information display operation of the image forming apparatus 5. According to the processing in step S2 in the flowchart in FIG. 5, the image forming apparatus 5 receives the N-th advertisement information from the advertisement information management server 4 (step S11) and displays this advertisement information on the touch panel display attached to the image forming apparatus 5 (step S12).

Consequently, the image forming apparatus 5 can display the advertisement information shown in FIG. 2 on the touch panel display. Thus, it is possible to expand the advertisement information into the screens shown in FIGS. 3 and 4 as described above.

FIG. 6(b) is a flowchart showing a flow of an advertisement information transmission operation of the image forming apparatus 5. When the image forming apparatus 5 detects that the cellular phone is held over the screen by detecting the IC card with the card reader 7 (step S13: an information reading step), the image forming apparatus 5 transmits advertisement information in display to the IC card (step S14: a transmitting step).

### Second Embodiment

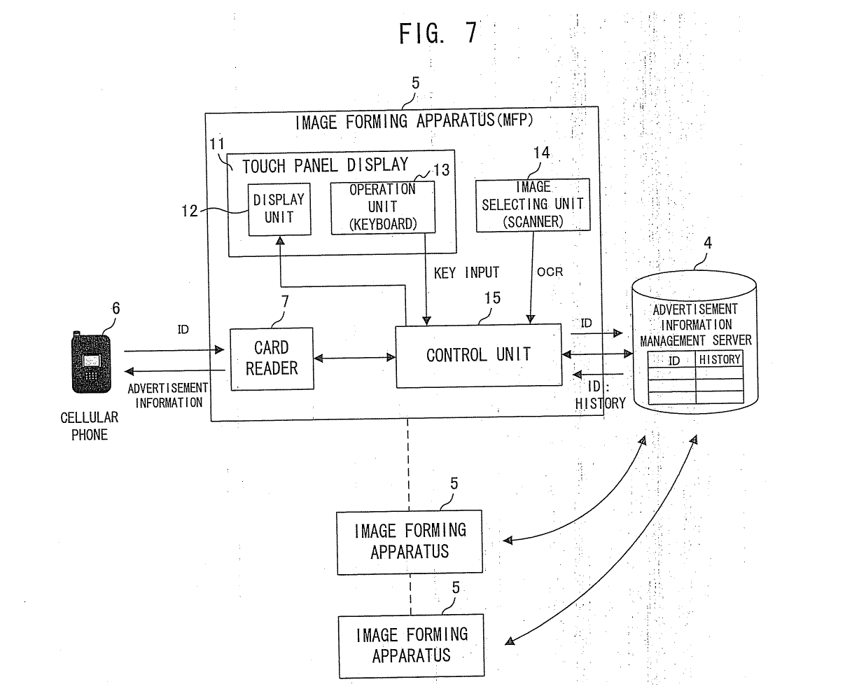

In a second embodiment, a structure in which an OCR function is added to the image forming apparatus 5 in the advertisement information management system shown in FIG. 1 will be explained. FIG. 7 is a block diagram of an advertisement information management system 1 applied to the second embodiment of the invention.

The image forming apparatus 5 shown in FIG. 7 includes a displaying unit 12 and an operation unit (a keyboard) 13 arranged on a touch panel display 11, an image selecting unit 14, a control unit 15 that treats key input information inputted from the operation unit 13 and OCR information inputted from the image selecting unit 14, and a card reader 7. Plural image forming apparatuses 5 are connected to the advertisement information management server 4.

The image selecting unit 14 has a scanner (an image scanning unit or image scanning means) and an OCR function. When the image selecting unit 14 scans an original with the scanner, the image selecting unit 14 performs character recognition with the OCR and performs predetermined character retrieval to acquire, for example, a title or an author name of a book or a character string with high frequency as a retrieval key for advertisement information. The image selecting unit 14 transmits the retrieval key acquired to the advertisement information management server 4 via the control unit 15.

The image selecting unit 14 constitutes an OCR unit or an OCR means of the invention.

The advertisement information management server 4, which has received the retrieval key, retrieves a title, an introductory sentence, a character string, or the like of advertisement information (e.g., book information) recorded in the database of the advertisement information management server 4 using the retrieval key and acquires advertisement information related to the retrieval key. The advertisement information management server 4 returns the advertisement information acquired to the image forming apparatus 5.

As this advertisement information, for example, as shown in FIG. 4(b), it is possible to display, for example, a “publication day”, an “author”, a “title”, and a “publishing company” related to an advertisement object commodity as a list.

The list of the advertisement information received by the image forming apparatus 5 is transmitted to the IC card in the cellular phone 6 when the user holds the cellular phone 6 over the card reader 7.

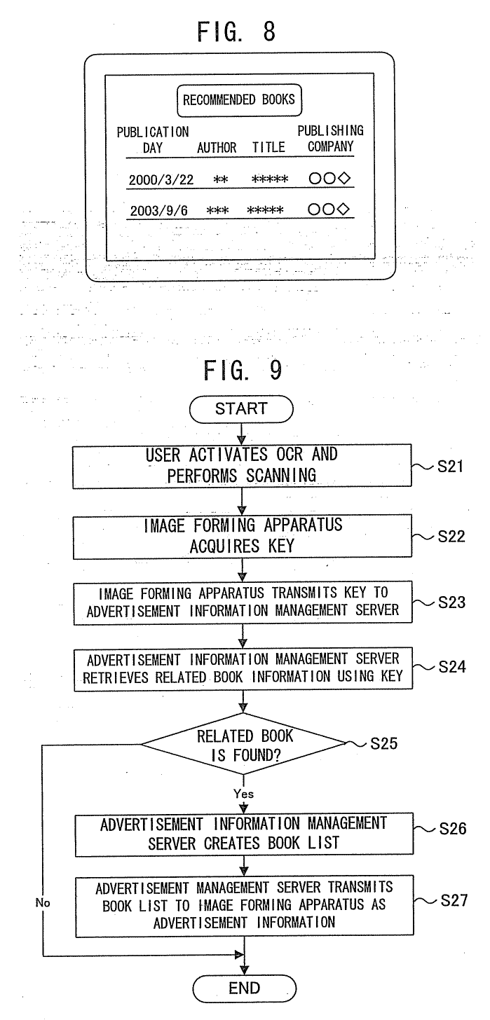

FIG. 8 is a diagram showing an example of a screen of a recommended book list acquired by the image selecting unit 14 of the image forming apparatus 5 shown in FIG. 7 on the basis of the retrieval key acquired by the OCR function according to the second embodiment of the invention.

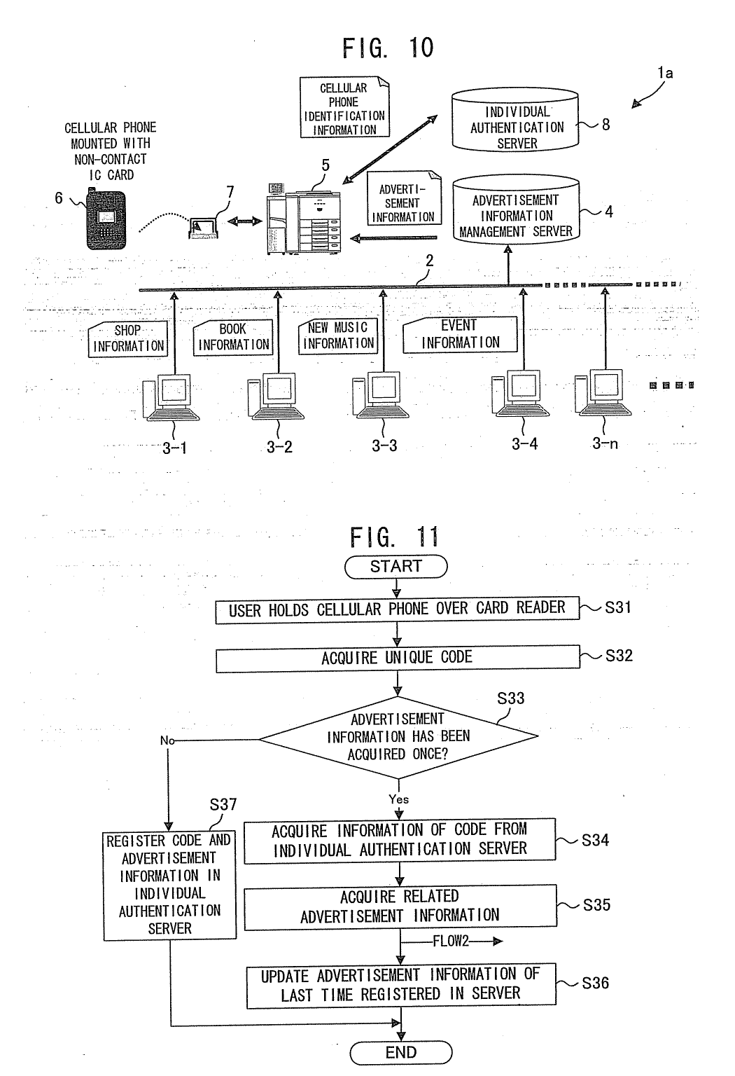

FIG. 9 is a flowchart showing an overall operation of the second embodiment of the invention.

First, the user performs setting for executing OCR and setting for creating a book list and performs scanning of an original after activating the OCR function (step S21). The image forming apparatus 5 acquires a title or a character string with high frequency as a retrieval key (step S22: an OCR recognition step) and transmits the retrieval key acquired to the advertisement information management server 4 (step S23).

The advertisement information management server 4 performs retrieval of related advertisement information using the retrieval key received from the image forming apparatus 5 (step S24: a key retrieving step). When “book information” is retrieved as the related advertisement information (step S25, Yes), the advertisement information management server 4 creates a book list (step S26) and transmits the book list created to the image forming apparatus 5 (step S27). Consequently, the user can acquire advertisement information with high retrieval accuracy. When “book information” is not retrieved (step S25, No), the advertisement information management server 4 stops the processing.

In the second embodiment described above, a key retrieval unit (key retrieval means) of the invention is provided in the advertisement information management server 4. However, the key retrieval unit (the key retrieval means) may be provided on the image forming apparatus 5 side. When the key retrieval unit (the key retrieval means) of the invention is provided in the advertisement information management server 4 as in the second embodiment, the advertisement information management apparatus of the invention is constituted by the image forming apparatus and the advertisement information management server.

### Third Embodiment

FIG. 10 is a conceptual diagram of an advertisement information management system applied to a third embodiment of the invention. An advertisement information management system 1a according to the third embodiment shown in FIG. 10 has a structure in which an individual authentication server 8 is added to the advertisement information management server system 1 according to the first embodiment shown in FIG. 1.

By using the image forming apparatus 5 that is capable of performing individual authentication (has a user authenticating unit or user authenticating means), when a user has held the cellular phone 6 over the card reader 7, at that point, a unique code corresponding to the cellular phone 6 and information on advertisement information desired by the user are recorded in the individual authentication server 8 (an advertisement-information-acquisition-history storing step). From the next time, when the user holds the cellular phone 6 over the card reader 7, it is possible to display advertisement information related to the information recorded in the individual authentication server 8 before displaying new arrival information.

This individual authentication server 8 may be provided in the image forming apparatus 5.

FIG. 11 is a flowchart showing a flow of advertisement information after user authentication in the advertisement information management system 1a shown in FIG. 10.

First, the user holds the cellular phone 6 over the card reader 7 (step S31). Consequently, the individual authentication server 8 reads the code, which is capable of uniquely specifying the cellular phone 6, via the card reader 7 of the image forming apparatus 5 using an individual authentication module included in the individual authentication server 8 (step S32).

Moreover, the individual authentication server 8 determines whether the code read from the cellular phone 6 is already recorded (step S33). When the user acquired advertisement information in the past (step S33, Yes), the individual authentication server 8 acquires advertisement information acquired before (the advertisement information acquired and stored in the advertisement-information-acquisition-history storing step) on the basis of the code read in step S32 (step S34).

Moreover, the individual authentication server 8 acquires advertisement information related to the advertisement information acquired in step S34 from the advertisement information management server 4 (step S35). In this case, the advertisement information to be acquired is information newer than the advertisement information acquired in step S34. The individual authentication server 8 replaces the advertisement information recorded in the individual authentication server 8 with the advertisement information acquired in step S35. In other words, the individual authentication server 8 updates the advertisement information to the last time registered therein (step S36: an advertisement-information-acquisition-history storing step).

When the advertisement information was not acquired in the past in step S33 (step S33: No), the individual authentication server 8 considers that the cellular phone 6 acquires the advertisement information for the first time and records the advertisement information in association with the code (step S37).

In the third embodiment, an advertisement-information-acquisition-history storing unit or advertisement-information-acquisition-history storing means and an advertisement-information selecting unit or advertisement-information selecting means are provided in the individual authentication server 8. However, the advertisement-information-acquisition-history storing unit or the advertisement-information-acquisition-history storing means and the advertisement-information selecting unit or the advertisement-information selecting means may be provided on the image forming apparatus 5 side. When the advertisement-information-acquisition-history storing unit or the advertisement-information-acquisition-history storing means of the invention are provided in the individual authentication server 8, the advertisement information management apparatus of the invention is constituted by the image forming apparatus 5 and the individual authentication server 8.

It is also possible to apply the advertisement-information displaying means, the reading and writing means, the retrieving means, the image scanning means, the OCR mans, the user authenticating means, and the advertisement-information-acquisition-history storing means explained in this embodiment to a program that causes a computer to execute the advertisement information management method explained according to the flowcharts described in the embodiment. This program has a function of being recorded in a computer-readable recording medium, read by the computer, and causing the computer to execute the advertisement information management method of the invention. Concerning such a function, in the explanation of this embodiment, the function of carrying out the invention is recorded in the apparatus in advance. However, the invention is not limited to this. The same function may be downloaded to the apparatus from a network or the same function stored in a recording medium may be installed in the apparatus. A form of the recording medium may be any form as long as the recording medium is a recording medium that can store a program and is readable by the apparatus such as a CD-ROM. The function obtained in advance by installation and download in this way may be realized in cooperation with an OS (operating system) or the like in the apparatus.

What is claimed is:

1. An advertisement information management apparatus comprising:
an advertisement-information displaying unit configured to acquire and display one or plural kinds of advertisement information; and
a reading and writing unit configured to read information recorded in an IC card and write new information in the IC card, wherein
the reading and writing unit transmits the advertisement information displayed by the advertisement-information displaying unit to the IC card by reading the information recorded in the IC card.

2. An advertisement information management apparatus according to claim 1, wherein the advertisement-information displaying unit displays the plural kinds of advertisement information acquired in order from one with a latest update date and time.

3. An advertisement information management apparatus according to claim 1, comprising a retrieving unit that can retrieve advertisement information to be displayed on the advertisement-information displaying unit out of the plural kinds of advertisement information on the basis of an instruction of a user, wherein
the advertisement-information displaying unit displays the advertisement information retrieved by the retrieving unit.

4. An advertisement information management apparatus according to claim 1, comprising:
an image scanning unit configured to scan an image; and
an OCR unit configured to extract a retrieval key concerning the advertisement information from the image scanned by the image scanning unit, wherein
the advertisement-information displaying unit displays predetermined advertisement information selected out of the plural kinds of advertisement information on the basis of the retrieval key.

5. An advertisement information management apparatus according to claim 4, comprising a key retrieval unit configured to retrieve and select the predetermined advertisement information out of the plural kinds of advertisement information on the basis of the retrieval key.

6. An advertisement information management apparatus according to claim 1, comprising:
a user authenticating unit configured to authenticate a user; and
an advertisement-information-acquisition-history storing unit configured to store an advertisement information acquisition history of the user authenticated by the user authenticating unit, wherein
the advertisement-information displaying unit displays the predetermined advertisement information selected out of the plural kinds of advertisement information on the basis of the history stored by the advertisement-information-acquisition-history storing unit.

7. An advertisement information management apparatus according to claim 6, comprising an advertisement-information selecting unit configured to select the predetermined advertisement information out of the plural kinds of advertisement information on the basis of the history stored by the advertisement-information-acquisition-history storing unit.

8. An advertisement information management apparatus comprising:
advertisement-information displaying means for acquiring and displaying one or plural kinds of advertisement information; and
reading and writing means for reading information recorded in an IC card and writing new information in the IC card, wherein
the reading and writing means transmits the advertisement information displayed by the advertisement-information displaying means to the IC card by reading the information recorded in the IC card.

9. An advertisement information management apparatus according to claim 8, wherein the advertisement-information displaying means displays the plural kinds of advertisement information acquired in order from one with a latest update date and time.

10. An advertisement information management apparatus according to claim 8, comprising retrieving means that can retrieve advertisement information to be displayed on the advertisement-information displaying means out of the plural kinds of advertisement information on the basis of an instruction of a user, wherein
the advertisement-information displaying means displays the advertisement information retrieved by the retrieving means.

11. An advertisement information management apparatus according to claim 8, comprising:
image scanning means for scanning an image; and
OCR means for extracting a retrieval key concerning the advertisement information from the image scanned by the image scanning means, wherein
the advertisement-information displaying means displays predetermined advertisement information selected out of the plural kinds of advertisement information on the basis of the retrieval key.

12. An advertisement information management apparatus according to claim 11, comprising key retrieval means for retrieving and selecting the predetermined advertisement information out of the plural kinds of advertisement information on the basis of the retrieval key.

13. An advertisement information management apparatus according to claim 8, comprising:
user authenticating means for authenticating a user; and
advertisement-information-acquisition-history storing means for storing an advertisement information acquisition history of the user authenticated by the user authenticating means, wherein
the advertisement-information displaying means displays the predetermined advertisement information selected out of the plural kinds of advertisement information on the basis of the history stored by the advertisement-information-acquisition-history storing means.

14. An advertisement information management apparatus according to claim 13, comprising advertisement-information selecting means for selecting the predetermined advertisement information out of the plural kinds of advertisement information on the basis of the history stored by the advertisement-information-acquisition-history storing means.

15. An advertisement information management method of causing a computer to execute management of advertisement information, the advertisement information management method comprising the steps of:
acquiring and displaying one or plural kinds of advertisement information;
reading information recorded in an IC card; and
transmitting the advertisement information displayed in the step of acquiring and displaying advertisement information to the IC card by reading the information recorded in the IC card in the step of reading information.

16. An advertisement information management method according to claim 15, wherein, in the step of acquiring and displaying advertisement information, the plural kinds of advertisement information acquired are displayed in order from one with a latest update date and time.

17. An advertisement information management method according to claim 15, comprising the step of retrieving advertisement information displayed in the step of acquiring and displaying advertisement information out of the plural kinds of advertisement information on the basis of an instruction of a user, wherein
in the step of acquiring and displaying advertisement information, the advertisement information retrieved in the step of retrieving advertisement information is displayed.

18. An advertisement information management method according to claim 15, comprising the steps of:
scanning an image; and
extracting a retrieval key concerning the advertisement information from the image scanned in the step of scanning an image, wherein
in the step of acquiring and displaying advertisement information, predetermined advertisement information selected out of the plural kinds of advertisement information is displayed on the basis of the retrieval key.

19. An advertisement information management method according to claim 18, comprising the step of retrieving and selecting the predetermined advertisement information out of the plural kinds of advertisement information on the basis of the retrieval key extracted in the step of extracting a retrieval key.

20. An advertisement information management method according to claim 15, comprising the steps of:
authenticating a user; and
storing an advertisement information acquisition history of the user authenticated in the step of authenticating the user, wherein
in the step of acquiring and displaying advertisement information, the predetermined advertisement information selected out of the plural kinds of advertisement information is displayed on the basis of the history stored in the step of storing an advertisement information acquisition history.
